(19) United States
(12) Patent Application Publication
(10) Pub. No.: US 2022/0243106 A1
(43) Pub. Date: Aug. 4, 2022

(54) HEAT TRANSFER COMPOSITIONS, METHODS, AND SYSTEMS

(71) Applicant: HONEYWELL INTERNATIONAL INC., Charlotte, NC (US)

(72) Inventors: Ankit Sethi, Charlotte, NC (US); Kaimi Gao, Charlotte, NC (US); Samuel Yana Motta, Charlotte, NC (US)

(73) Assignee: HONEYWELL INTERNATIONAL INC., Charlotte, NC (US)

(21) Appl. No.: 17/591,375

(22) Filed: Feb. 2, 2022

Related U.S. Application Data
(60) Provisional application No. 63/145,437, filed on Feb. 3, 2021.

(51) Int. Cl. C09K 5/04

(52) U.S. Cl. CPC C09K 5/045; C09K 2205/22; C09K 2205/122; C09K 2205/128

(57) ABSTRACT

The present invention relates to a refrigerant composition comprising at least about 98.5% by weight of the following three compounds, with each compound being present in the following relative percentages:
16.5% to 21.5% by weight difluoromethane (HFC-32);
68.5% to 80.5% by weight of 2,3,3,3-tetrafluoropropene (HFO-1234yf); and
   3.0% to 10.0% by weight fluoroethane (HFC-161), and to the use of the refrigerant in a heat exchange system, including air conditioning, refrigeration applications and heat pump applications and to the use of such compositions as a replacement of the refrigerant R-410A or R1234yf for heating and cooling applications.

### CROSS REFERENCE TO RELATED APPLICATIONS

This application is related to and claims the priority benefit of U.S. Provisional Application No. 63/145,437 filed Feb. 3, 2021, incorporated herein by reference.

### FIELD OF THE INVENTION

This invention relates to compositions, methods, and systems having utility in refrigeration applications, with particular benefit in residential air conditioning, residential heat pumps, commercial air conditioning systems, and in particular aspects to refrigerant compositions for replacement of the refrigerant R-410A and/or HFO-1234yf for various heating and cooling applications, including: (1) as a replacement or retrofit for R-410, and particularly R-410A in residential air conditioning, variable refrigerant flow air conditioning, residential heat pumps, commercial air conditioning systems, commercial air conditioning chillers, residential air-to-water heat pump hydronic systems, medium temperature refrigeration and low temperature refrigeration, including systems designed for use with R-410A, and (2) as a replacement for HFO-1234yf in mobile air conditioning, and mobile heat pumps, including systems designed for use with HFO-1234yf.

### BACKGROUND

Mechanical refrigeration systems, and related heat transfer devices such as heat pumps, chillers, and air conditioners, using refrigerant liquids are well known in the art for industrial, commercial, and domestic uses. Several fluorocarbon-based fluids have found widespread use in many residential, commercial, and industrial applications, including as the working fluid in systems such as air conditioning, heat pump and refrigeration systems. Because of certain suspected environmental problems, including the relatively high global warming potentials associated with the use of some hydrofluorocarbon (“HFC”) based compositions that have heretofore been used in these applications, it has become increasingly desirable to use fluids having global warming potentials (“GWPs”) less than 150.

A commonly used refrigerant in many applications has been R-410A (50:50 by weight blend of pentafluoroethane (HFC-125) and difluoromethane (HFC-32) in an approximate 44:52:4 weight percent). R-404A has an estimated GWP of 2088.

It is generally considered important, however, with respect to heat transfer fluids, that any potential sub-150 GWP substitute for R-410A must also possess those properties present in many of the most widely used HFC based fluids, such as excellent heat transfer properties, chemical stability, low- or no- toxicity, non-flammability, and lubricant compatibility, among others. In addition, any sub-150 GWP replacement would desirably be a good enough match for the operating conditions of R-410A in non-mobile systems and for HFO-1234yf in mobile systems to minimize needed modification or redesign of the system.

Regarding efficiency in use, it is important to note that a loss in refrigerant thermodynamic performance or energy efficiency may have secondary environmental impacts through increased fossil fuel usage arising from an increased demand for electrical energy. In other words, a proposed new refrigerant that has a GWP below 150 might nevertheless be less environmentally friendly than the fluid it is replacing if another characteristic of the proposed new fluid, such as efficiency in use, results in increased environmental emissions indirectly, such as by requiring higher fuel combustion to achieve the same level of refrigeration. It is thus seen that the selection of a replacement is a complicated, challenging endeavor that may not have predictable results.

Furthermore, it is generally considered desirable for HFC refrigerant substitutes to be effective without major engineering changes to conventional vapor compression technology currently used with HFC refrigerants.

It is critical for maintenance of system efficiency and proper and reliable functioning of the compressor, that lubricant circulating in a vapor compression heat transfer system is returned to the compressor to perform its intended lubricating function. Otherwise, lubricant might accumulate and become lodged in the coils and piping of the system, including in the heat transfer components. Furthermore, when lubricant accumulates on the inner surfaces of the evaporator, it lowers the heat exchange efficiency of the evaporator, and thereby reduces the efficiency of the system. For these reasons, it is desirable for many systems that the refrigerant is miscible over at least the operating temperature range of the system with the lubricant that is used in the system.

Since R-410A is currently commonly used with polyol ester (POE) lubricating oils, a proposed R-410A replacement refrigerant is desirably miscible with POE lubricants over the temperature range in the system and for the concentrations of lubricant that are present in the system, particularly over the operating temperature ranges in the condenser and evaporator.

Since HFO-1234yf is currently commonly used with polyalkylene glycol (PAG) lubricating oils, a proposed HFO-1234yf replacement refrigerant is desirably miscible with lubricants that might be used in such systems, including for example PAG lubricants, PVE lubricants and PVE lubricants over the temperature range in the system and for the concentrations of lubricant that are present in the system, particularly over the operating temperature ranges in the condenser and evaporator.

Applicants have thus come to appreciate a need for compositions, and particularly heat transfer compositions, that are highly advantageous in heating and cooling systems and methods, particularly including in residential air conditioning, variable refrigerant flow air conditioning, residential heat pumps, commercial air conditioning chillers, residential air-to-water heat pump hydronic systems, medium temperature refrigeration, low temperature refrigeration, mobile air conditioning, and mobile heat pumps, that have been designed for use with or are suitable for use with R-410A.

### SUMMARY OF THE INVENTION

Applicants have found that the compositions of the present invention satisfy in an exceptional and unexpected way the need for sub-150 GWP alternatives and/or replacements for R-410A that are only mildly flammable (i.e., have a 2L classification according to ANSI/ASHRAE 34-2019, Designation and Safety Classification of Refrigerants) non-toxic fluids that have a close match in cooling efficiency and capacity to R-410A in refrigeration applications in such systems and which also preferably have a glide that is not excessively high. As used herein, the term “sub-150 GWP” is used for convenience to refer to refrigerants which have a GWP (measured as described hereinafter) of 150 or less.

The present invention relates to a refrigerant comprising at least about 98.5% by weight of the following three compounds, with each compound being present in the following relative percentages:
16.5% to 21.5% by weight difluoromethane (HFC-32);
68.5% to 80.5% by weight of 2,3,3,3-tetrafluoropropene (HFO-1234yf); and
3.0% to 10.0% by weight fluoroethane (HFC-161). Refrigerants as described in this paragraph are sometimes referred to for convenience as Refrigerant 1.

The present invention relates to a refrigerant comprising at least about 98.5% by weight of the following three compounds, with each compound being present in the following relative percentages:
18.5% to 21.5% by weight difluoromethane (HFC-32);
68.5% to 72.5% by weight of 2,3,3,3-tetrafluoropropene (HFO-1234yf); and
6.0% to 9.0% by weight fluoroethane (HFC-161). Refrigerants as described in this paragraph are sometimes referred to for convenience as Refrigerant 3.

The present invention relates to a refrigerant comprising at least about 98.5% by weight of the following three compounds, with each compound being present in the following relative percentages:
about 21.5% by weight difluoromethane (HFC-32);
about 70.5% by weight of 2,3,3,3-tetrafluoropropene (HFO-1234yf); and
about 8.0% by weight fluoroethane (HFC-161). Refrigerants as described in this paragraph are sometimes referred to for convenience as Refrigerant 4.

The present invention relates to a refrigerant comprising at least about 98.5% by weight of the following three compounds, with each compound being present in the following relative percentages:
21.5%+0.5/−2% by weight difluoromethane (HFC-32);
69.5%+/−2% by weight of 2,3,3,3-tetrafluoropropene (HFO-1234yf); and
9.0%+0.5/−2% by weight fluoroethane (HFC-161). Refrigerants as described in this paragraph are sometimes referred to for convenience as Refrigerant 5.

The present invention relates to a refrigerant comprising at least about 98.5% by weight of the following three compounds, with each compound being present in the following relative percentages:
21.5%+0.5/−2% by weight difluoromethane (HFC-32);
70.5%+/−2% by weight of 2,3,3,3-tetrafluoropropene (HFO-1234yf); and
8.0%+0.5/−2% by weight fluoroethane (HFC-161). Refrigerants as described in this paragraph are sometimes referred to for convenience as Refrigerant 6.

The present invention relates to a refrigerant comprising at least about 98.5% by weight of the following three compounds, with each compound being present in the following relative percentages:
21.5%+0.5/−2% by weight difluoromethane (HFC-32);
71.5%+/−2% by weight of 2,3,3,3-tetrafluoropropene (HFO-1234yf); and
7.0%+0.5/−2% by weight fluoroethane (HFC-161). Refrigerants as described in this paragraph are sometimes referred to for convenience as Refrigerant 7.

The present invention relates to a refrigerant comprising at least about 99.5% by weight of the following three compounds, with each compound being present in the following relative percentages:
16.5% to 21.5% by weight difluoromethane (HFC-32);
68.5% to 80.5% by weight of 2,3,3,3-tetrafluoropropene (HFO-1234yf); and
3.0% to 10.0% by weight fluoroethane (HFC-161). Refrigerants as described in this paragraph are sometimes referred to for convenience as Refrigerant 8.

The present invention relates to a refrigerant comprising at least about 99.5% by weight of the following three compounds, with each compound being present in the following relative percentages:
18.5% to 21.5% by weight difluoromethane (HFC-32);
68.5% to 72.5% by weight of 2,3,3,3-tetrafluoropropene (HFO-1234yf); and
6.0% to 9.0% by weight fluoroethane (HFC-161). Refrigerants as described in this paragraph are sometimes referred to for convenience as Refrigerant 9.

The present invention relates to a refrigerant comprising at least about 99.5% by weight of the following three compounds, with each compound being present in the following relative percentages:
about 21.5% by weight difluoromethane (HFC-32);
about 70.5% by weight of 2,3,3,3-tetrafluoropropene (HFO-1234yf); and
about 8.0% by weight fluoroethane (HFC-161). Refrigerants as described in this paragraph are sometimes referred to for convenience as Refrigerant 10.

The present invention relates to a refrigerant comprising at least about 99.5% by weight of the following three compounds, with each compound being present in the following relative percentages:
21.5% +0.5/−2% by weight difluoromethane (HFC-32);
69.5% +/−2% by weight of 2,3,3,3-tetrafluoropropene (HFO-1234yf); and
9.0% +0.5/−2% by weight fluoroethane (HFC-161). Refrigerants as described in this paragraph are sometimes referred to for convenience as Refrigerant 11.

The present invention relates to a refrigerant comprising at least about 99.5% by weight of the following three compounds, with each compound being present in the following relative percentages:
21.5% +0.5/−2% by weight difluoromethane (HFC-32);
70.5% +/−2% by weight of 2,3,3,3-tetrafluoropropene (HFO-1234yf); and
8.0% +0.5/−2% by weight fluoroethane (HFC-161). Refrigerants as described in this paragraph are sometimes referred to for convenience as Refrigerant 12.

The present invention relates to a refrigerant comprising at least about 99.5% by weight of the following three compounds, with each compound being present in the following relative percentages:
21.5% +0.5/−2% by weight difluoromethane (HFC-32);
71.5% +/−2% by weight of 2,3,3,3-tetrafluoropropene (HFO-1234yf); and
7.0% +0.5/−2% by weight fluoroethane (HFC-161). Refrigerants as described in this paragraph are sometimes referred to for convenience as Refrigerant 13.

The present invention relates to a refrigerant consisting essentially of the following three compounds, with each compound being present in the following relative percentages:
16.5% to 21.5% by weight difluoromethane (HFC-32);
68.5% to 80.5% by weight of 2,3,3,3-tetrafluoropropene (HFO-1234yf); and
3.0% to 10.0% by weight fluoroethane (HFC-161). Refrigerants as described in this paragraph are sometimes referred to for convenience as Refrigerant 14

The present invention relates to a refrigerant consisting essentially of the following three compounds, with each compound being present in the following relative percentages:
18.5% to 21.5% by weight difluoromethane (HFC-32);
68.5% to 72.5% by weight of 2,3,3,3-tetrafluoropropene (HFO-1234yf); and
6.0% to 9.0% by weight fluoroethane (HFC-161). Refrigerants as described in this paragraph are sometimes referred to for convenience as Refrigerant 15.

The present invention relates to a refrigerant consisting essentially of the following three compounds, with each compound being present in the following relative percentages:
about 21.5% by weight difluoromethane (HFC-32);
about 70.5% by weight of 2,3,3,3-tetrafluoropropene (HFO-1234yf); and
about 8.0% by weight fluoroethane (HFC-161). Refrigerants as described in this paragraph are sometimes referred to for convenience as Refrigerant 16.

The present invention relates to a refrigerant consisting essentially of the following three compounds, with each compound being present in the following relative percentages:
21.5%+0.5/−2% by weight difluoromethane (HFC-32);
69.5%+/−2% by weight of 2,3,3,3-tetrafluoropropene (HFO-1234yf); and
9.0%+0.5/−2% by weight fluoroethane (HFC-161). Refrigerants as described in this paragraph are sometimes referred to for convenience as Refrigerant 17.

The present invention relates to a refrigerant consisting essentially of the following three compounds, with each compound being present in the following relative percentages:
21.5%+0.5/−2% by weight difluoromethane (HFC-32);
70.5%+/−2% by weight of 2,3,3,3-tetrafluoropropene (HFO-1234yf); and
8.0%+0.5/−2% by weight fluoroethane (HFC-161). Refrigerants as described in this paragraph are sometimes referred to for convenience as Refrigerant 18.

The present invention relates to a refrigerant consisting essentially of the following three compounds, with each compound being present in the following relative percentages:
21.5%+0.5/−2% by weight difluoromethane (HFC-32);
71.5%+/−2% by weight of 2,3,3,3-tetrafluoropropene (HFO-1234yf); and
7.0%+0.5/−2% by weight fluoroethane (HFC-161). Refrigerants as described in this paragraph are sometimes referred to for convenience as Refrigerant 19.

The present invention relates to a refrigerant consisting of the following three compounds, with each compound being present in the following relative percentages:
16.5% to 21.5% by weight difluoromethane (HFC-32);
68.5% to 80.5% by weight of 2,3,3,3-tetrafluoropropene (HFO-1234yf); and
3.0% to 10.0% by weight fluoroethane (HFC-161). Refrigerants as described in this paragraph are sometimes referred to for convenience as Refrigerant 20

The present invention relates to a refrigerant consisting of the following three compounds, with each compound being present in the following relative percentages:
18.5% to 21.5% by weight difluoromethane (HFC-32);
68.5% to 72.5% by weight of 2,3,3,3-tetrafluoropropene (HFO-1234yf); and
6.0% to 9.0% by weight fluoroethane (HFC-161). Refrigerants as described in this paragraph are sometimes referred to for convenience as Refrigerant 21.

The present invention relates to a refrigerant consisting of the following three compounds, with each compound being present in the following relative percentages:
about 21.5% by weight difluoromethane (HFC-32);
about 70.5% by weight of 2,3,3,3-tetrafluoropropene (HFO-1234yf); and
about 8.0% by weight fluoroethane (HFC-161). Refrigerants as described in this paragraph are sometimes referred to for convenience as Refrigerant 22.

The present invention relates to a refrigerant of the following three compounds, with each compound being present in the following relative percentages:
21.5%+0.5/−2% by weight difluoromethane (HFC-32);
69.5%+/−2% by weight of 2,3,3,3-tetrafluoropropene (HFO-1234yf); and
9.0%+0.5/−2% by weight fluoroethane (HFC-161). Refrigerants as described in this paragraph are sometimes referred to for convenience as Refrigerant 23.

The present invention relates to a refrigerant consisting of the following three compounds, with each compound being present in the following relative percentages:
21.5%+0.5/−2% by weight difluoromethane (HFC-32);
70.5%+/−2% by weight of 2,3,3,3-tetrafluoropropene (HFO-1234yf); and
8.0%+0.5/−2% by weight fluoroethane (HFC-161). Refrigerants as described in this paragraph are sometimes referred to for convenience as Refrigerant 24.

The present invention relates to a refrigerant consisting of the following three compounds, with each compound being present in the following relative percentages:
21.5%+0.5/−2% by weight difluoromethane (HFC-32);
71.5%+/−2% by weight of 2,3,3,3-tetrafluoropropene (HFO-1234yf); and
7.0%+0.5/−2% by weight fluoroethane (HFC-161). Refrigerants as described in this paragraph are sometimes referred to for convenience as Refrigerant 25.

### BRIEF DESCRIPTION OF THE DRAWINGS

FIG. 1 is a schematic representation of an exemplary heat transfer system useful in air conditioning, low temperature refrigeration and medium temperature refrigeration.

FIG. 2 is a schematic representation of an exemplary heat transfer system useful in low and medium temperature refrigeration and which includes a vapor injector.

FIG. 3 is a schematic representation of an exemplary heat transfer system useful in low and medium temperature refrigeration and which includes a liquid injector.

FIG. 4 is a schematic representation of an exemplary heat transfer system useful in low and medium temperature refrigeration and which includes a suction line/liquid line heat exchanger.

FIG. 5 is a schematic representation of an exemplary heat transfer system useful in low and medium temperature refrigeration and which includes a vapor injector and an oil separator.

### DETAILED DESCRIPTION OF THE INVENTION

### Definitions:

For the purposes of this invention, the term “about” in relation to the amounts expressed in weight percent means that the amount of the component can vary by an amount of +/−2% by weight. For the purposes of this invention, the term “about” in relation to temperatures in degrees centigrade (° C.) means that the stated temperature can vary by an amount of +/−5° C.

The term “capacity” is the amount of cooling provided, in BTUs/hr., by the refrigerant in the refrigeration system. This is experimentally determined by multiplying the change in enthalpy in BTU/lb., of the refrigerant as it passes through the evaporator by the mass flow rate of the refrigerant. The enthalpy can be determined from the measurement of the pressure and temperature of the refrigerant. The capacity of the refrigeration system relates to the ability to maintain an area to be cooled at a specific temperature. The capacity of a refrigerant represents the amount of cooling or heating that it provides and provides some measure of the capability of a compressor to pump quantities of heat for a given volumetric flow rate of refrigerant. In other words, given a specific compressor, a refrigerant with a higher capacity will deliver more cooling or heating power.

The phrase “coefficient of performance” (hereinafter “COP”) is a universally accepted measure of refrigerant performance, especially useful in representing the relative thermodynamic efficiency of a refrigerant in a specific heating or cooling cycle involving evaporation or condensation of the refrigerant. In refrigeration engineering, this term expresses the ratio of useful refrigeration or cooling capacity to the energy applied by the compressor in compressing the vapor and therefore expresses the capability of a given compressor to pump quantities of heat for a given volumetric flow rate of a heat transfer fluid, such as a refrigerant. In other words, given a specific compressor, a refrigerant with a higher COP will deliver more cooling or heating power. One means for estimating COP of a refrigerant at specific operating conditions is from the thermodynamic properties of the refrigerant using standard refrigeration cycle analysis techniques (see for example, R. C. Downing, FLUOROCARBON REFRIGERANTS HANDBOOK, Chapter 3, Prentice-Hall, 1988 which is incorporated herein by reference in its entirety).

The phrase “discharge temperature” refers to the temperature of the refrigerant at the outlet of the compressor. The advantage of a low discharge temperature is that it permits the use of existing equipment without activation of the thermal protection aspects of the system which are preferably designed to protect compressor components and avoids the use of costly controls such as liquid injection to reduce discharge temperature.

The phrase “Global Warming Potential” (hereinafter “GWP”) was developed to allow comparisons of the global warming impact of different gases. Specifically, it is a measure of how much energy the emission of one ton of a gas will absorb over a given period of time, relative to the emission of one ton of carbon dioxide. The larger the GWP, the more that a given gas warms the Earth compared to CO2 over that time period. The time period usually used for GWP is 100 years. GWP provides a common measure, which allows analysts to add up emission estimates of different gases. See http://www.protocolodemontreal.org.br/site/images/publicacoes/setor_manufatura_equipam entos_refrigeracao_arcondicionado/Como_calcular_el_Potencial_de_Calentamiento_Atmos ferico_en_las_mezclas_de_refrigerantes.pdf

The term “Occupational Exposure Limit (OEL)” is determined in accordance with ASHRAE Standard 34-2016 Designation and Safety Classification of Refrigerants.

The term “mass flow rate” is the mass of refrigerant passing through a conduit per unit of time.

As used herein, the term “replacement” means the use of a composition of the present invention in a heat transfer system that had been designed for use with, or is commonly used with, or is suitable for use with another refrigerant. By way of example, when a refrigerant or heat transfer composition of the present invention is used in a heat transfer system that was designed for use with R-404A, then the refrigerant or heat transfer composition of the present invention is a replacement for R-404A in said system. It will thus be understood that the term “replacement” includes the use of the refrigerants and heat transfer compositions of the present invention in both new and existing systems that had been designed for use with, are commonly used with, or are suitable for use with R-404A. The phrase “thermodynamic glide” applies to zeotropic refrigerant mixtures that have varying temperatures during phase change processes in the evaporator or condenser at constant pressure.

The term “low temperature refrigeration system” refers to heat transfer systems which operate with a condensing temperature of from about 20° C. to about 60° C. and evaporating temperature of from about −45° C. up to and including −12° C.

The term “medium temperature refrigeration system” refers to heat transfer systems which operate with a condensing temperature of from about 20° C. to about 60° C. and evaporating temperature of from −12° C. to about 0° C.

The term “medium temperature refrigeration system” refers to heat transfer systems which operate with a condensing temperature of from about 20° C. to about 60° C. and evaporating temperature of from −12° C. to about 0° C.

The term “residential air conditioning” as used herein refers to heat transfer systems to condition air (cooling or heating) which operate with a condensing temperature of from about 20° C. to about 70° C. and evaporating temperature of from about 0° C. to about 20° C.

The term “residential air-to-water heat pump” as used herein refers to heat transfer systems which transfer heat from outdoor air to water within the residence, which water is in turn used to condition the air in the residence and which operates with a condensing temperature of from about 20° C. to about 70° C. and evaporating temperature of from about −20° C. to about 3° C.

The term “air cooled chillers” as used herein refers to heat transfer systems which transfer heat to or from process water (typically used to cool or heat the inside of buildings) and reject or absorb heat from ambient air and which operate with a condensing temperature of from about 20° C. to about 70° C. and evaporating temperature of from about 0° C. to about 10° C.

The term “supermarket refrigeration” as used herein refers to commercial refrigeration systems that are used to maintain chilled or frozen food in both product display cases and storage refrigerators.

The term “transport refrigeration” as used herein refers to refrigeration system that are used in the transportation of chilled or frozen products by means of trucks, trailers, vans, intermodal containers, and boxes. The term also includes the use of refrigeration and air conditioning on merchant, naval and fishing vessels above about 100 gross tons (GT) (over about 24 m in length).

The terms “HFO-1234yf” and “R-1234yf” as used herein each mean 2,3,3,3-tetrafluoropropene.

The terms “HFC-32” and “R-32” as used herein each mean difluoromethane.

The terms “HFC-161” and “R-161” as used herein each mean fluoroethane.

The term “R-410A” means a blend of refrigerants consisting of 50 wt.% of R-32 and 50 wt.% of R-125.

The term “R-410B” means a blend of refrigerants consisting of 45 wt.% of R-32 and 55 wt.% of R-125.

The term “R-410” means either of R-410A or R-410B.

The term “R-454B” as used herein means a refrigerant comprising a blend of 68.9% by weight of R-32 and 31.1% by weight of R-1234yf.

Reference herein to a group of defined items includes all such defined items, including all such items with suffix designations.

### Refrigerants and Heat Transfer Compositions

Applicants have found that the refrigerant of the present invention, including each of Refrigerants 1-25 as described herein, is capable of providing exceptionally advantageous properties including: heat transfer properties, low or no toxicity, mild flammability, near zero ozone depletion potential (“ODP”), and lubricant compatibility, including miscibility with POE and/or PVE lubricants over the operating temperature and concentration ranges used in residential air conditioning, variable refrigerant flow air conditioning, residential heat pumps, commercial air conditioning chillers, residential air-to-water heat pump hydronic systems, medium temperature refrigeration, low temperature refrigeration, mobile air conditioning, and mobile heat pumps.

A particular advantage of the refrigerants of the present invention, including each of Refrigerants 1-25, is that they are mildly flammable. It will be appreciated by the skilled person that the flammability of a refrigerant can be characteristic that is given consideration in certain important heat transfer applications, and that refrigerants that are classified as 2L can frequently be an advantage over refrigerants that are considered to be flammable. Thus, it is a desire in the art to provide a refrigerant composition which can be used as a replacement 410A which has excellent heat transfer properties, low or no toxicity, near zero ODP, and lubricant compatibility, including miscibility with POE and/or PVE lubricants over the operating temperature and concentration ranges used in residential air conditioning, variable refrigerant flow air conditioning, residential heat pumps, commercial air conditioning chillers, residential air-to-water heat pump hydronic systems, medium temperature refrigeration, low temperature refrigeration, mobile air conditioning, and mobile heat pumps, and which maintains non-flammability in use. This desirable advantage can be achieved met by the refrigerants of the present invention.

Another particular advantage of the refrigerants of the present invention, including each of Refrigerants 1-25, is that exhibit an excellent match to the capacity and COP of R-410A in residential air conditioning, variable refrigerant flow air conditioning, residential heat pumps, commercial air conditioning chillers, residential air-to-water heat pump hydronic systems, medium temperature refrigeration, low temperature refrigeration, mobile air conditioning, and mobile heat pumps which provide the unexpected advantage of excellent performance in retrofit applications, especially for R-410A systems.

Applicants have found that the refrigerant compositions of the invention, including each of Refrigerants 1-25, are capable of achieving a difficult to achieve combination of properties including particularly low GWP. Thus, the compositions of the invention have a GWP of 150 or less and preferably 147 or less.

In addition, the refrigerant compositions of the invention, including each of Refrigerants 1-25, have a low ODP. Thus, the compositions of the invention have an ODP of not greater than 0.05, preferably not greater than 0.02, and more preferably about zero.

In addition, the refrigerant compositions of the invention, including each of Refrigerants 1-25, show acceptable toxicity and preferably have an OEL of greater than about 400. As those skilled in the art are aware, a non-flammable refrigerant that has an OEL of greater than about 400 is advantageous since it results in the refrigerant being classified in the desirable Class A of ASHRAE standard 34.

Applicants have found that the heat transfer compositions of the present invention, including heat transfer compositions that include each of Refrigerants 1-25 as described herein, is capable of providing exceptionally advantageous properties including: heat transfer properties, chemical stability under the conditions of use, low or no toxicity, non-flammability, near zero ozone depletion potential (“ODP”), and lubricant compatibility, including miscibility with POE and/or PVE lubricants over the operating temperature and concentration ranges used in residential air conditioning, variable refrigerant flow air conditioning, residential heat pumps, commercial air conditioning chillers, residential air-to-water heat pump hydronic systems, medium temperature refrigeration, low temperature refrigeration, mobile air conditioning, and mobile heat pumps, as well as sub-150 GWP, especially as a replacement for R-410A in residential air conditioning, variable refrigerant flow air conditioning, residential heat pumps, commercial air conditioning chillers, residential air-to-water heat pump hydronic systems, medium temperature refrigeration, low temperature refrigeration, mobile air conditioning, and mobile heat pumps, including in prior R-410A systems.

The heat transfer compositions can consist essentially of any refrigerant of the present invention, including each of Refrigerants 1-25.

The heat transfer compositions of the present invention can consist of any refrigerant of the present invention, including each of Refrigerants 1-25.

The heat transfer compositions of the invention may include other components for the purpose of enhancing or providing certain functionality to the compositions. Such other components may include one or more of lubricants, dyes, solubilizing agents, compatibilizers, stabilizers, antioxidants, corrosion inhibitors, extreme pressure additives and anti-wear additives.

Lubricants

The heat transfer composition of the invention particularly comprises a refrigerant as described herein, including each of Refrigerants 1-25, and a lubricant. Applicants have found that the heat transfer compositions of the present invention, including heat transfer compositions that include a lubricant, and particularly a POE and/or PVE lubricant and each of Refrigerants 1-25 as described herein, is capable of providing exceptionally advantageous properties including, in addition to the advantageous properties identified herein with respect to the refrigerant, excellent refrigerant/lubricant compatibility, including miscibility with POE and/or PVE lubricants over the operating temperature and concentration ranges used in residential air conditioning, variable refrigerant flow air conditioning, residential heat pumps, commercial air conditioning chillers, residential air-to-water heat pump hydronic systems, medium temperature refrigeration, low temperature refrigeration, mobile air conditioning, and mobile heat pumps, especially as a replacement for R-410 in such systems, including air conditioning in trucks and buses and chiller systems.

The heat transfer composition of the invention particularly comprises a refrigerant as described herein, including each of Refrigerants 1-25, and a lubricant. Applicants have found that the heat transfer compositions of the present invention, including heat transfer compositions that include a lubricant, and particularly a PAG lubricant and each of Refrigerants 1-25 as described herein, is capable of providing exceptionally advantageous properties including, in addition to the advantageous properties identified herein with respect to the refrigerant, excellent refrigerant/lubricant compatibility, including miscibility with PAG lubricants over the operating temperature and concentration ranges used in residential air conditioning, variable refrigerant flow air conditioning, residential heat pumps, commercial air conditioning chillers, residential air-to-water heat pump hydronic systems, medium temperature refrigeration, low temperature refrigeration, mobile air conditioning, and mobile heat pumps, especially as a replacement R-1234yf in such systems, including air conditioning in cars, trucks and buses and chiller systems.

In general, the heat transfer compositions of the present invention that include a lubricant comprise lubricant in amounts preferably of from about 0.1% by weight to about 5%, or from 0.1% by weight to about 1% by weight, or from 0.1% by weight to about 0.5% by weight, based on the weight of the heat transfer composition.

Commonly used refrigerant lubricants such as polyol esters (POEs), polyalkylene glycols (PAGs), silicone oils, mineral oil, alkylbenzenes (ABs), polyvinyl ethers (PVEs), polyethers (PEs) and poly(alpha-olefin) (PAO) that are used in refrigeration machinery may be used with the refrigerant compositions of the present invention.

Preferably the lubricants are selected from PAGs, POEs, and PVE.

Preferably the lubricants are POEs.

Preferably the lubricants are PVEs.

Preferably the lubricants are PAGs.

In general, the heat transfer compositions of the present invention that include POE lubricant comprise POE lubricant in amounts preferably of from about 0.1% by weight to about 5%, or from 0.1% by weight to about 1% by weight, or from 0.1% by weight to about 0.5% by weight, based on the weight of the heat transfer composition.

Commercially available POEs that are preferred for use in the present heat transfer compositions include neopentyl glycol dipelargonate which is available as Emery 2917 (registered trademark) and Hatcol 2370 (registered trademark) and pentaerythritol derivatives including those sold under the trade designations Emkarate RL32-3MAF and Emkarate RL68H by CPI Fluid Engineering. Emkarate RL32-3MAF and Emkarate RL68H are preferred POE lubricants having the properties identified below:

| Property | RL32-3MAF | RL68H |
|---|---|---|
| Viscosity | about 31 | about 67 |
| @ 40° C. (ASTM D445), cSt | | |
| Viscosity | about 5.6 | about 9.4 |
| @ 100° C. (ASTM D445), cSt | | |
| Pour Point | about −40 | about −40 |
| (ASTM D97), ° C. | | |

In general, the heat transfer compositions of the present invention that include PVE lubricant comprise PVE lubricant in amounts preferably of from about 0.1% by weight to about 5%, or from 0.1% by weight to about 1% by weight, or from 0.1% by weight to about 0.5% by weight, based on the weight of the heat transfer composition.

Commercially available polyvinyl ethers that are preferred for use in the present heat transfer compositions include those lubricants sold under the trade designations FVC32D and FVC68D, from Idemitsu.

Commercially available PAG lubricants are preferred for use in the present heat transfer compositions include those lubricants sold under the trade designations Nippon-Denso ND oil-8, ND oil-12; Idemitsu PS-D1; Sanden SP-10.

A preferred heat transfer composition comprises Refrigerant 1 and POE lubricant.

A preferred heat transfer composition comprises Refrigerant 2 and POE lubricant.

A preferred heat transfer composition comprises Refrigerant 3 and POE lubricant.

A preferred heat transfer composition comprises Refrigerant 4 and POE lubricant.

A preferred heat transfer composition comprises Refrigerant 5 and POE lubricant.

A preferred heat transfer composition comprises Refrigerant 6 and POE lubricant.

A preferred heat transfer composition comprises Refrigerant 7 and POE lubricant.

A preferred heat transfer composition comprises Refrigerant 8 and POE lubricant.

A preferred heat transfer composition comprises Refrigerant 9 and POE lubricant.

A preferred heat transfer composition comprises Refrigerant 10 and POE lubricant.

A preferred heat transfer composition comprises Refrigerant 11 and POE lubricant.

A preferred heat transfer composition comprises Refrigerant 12 and POE lubricant.

A preferred heat transfer composition comprises Refrigerant 13 and POE lubricant.

A preferred heat transfer composition comprises Refrigerant 14 and POE lubricant.

A preferred heat transfer composition comprises Refrigerant 15 and POE lubricant.

A preferred heat transfer composition comprises Refrigerant 16 and POE lubricant.

A preferred heat transfer composition comprises Refrigerant 17 and POE lubricant.

A preferred heat transfer composition comprises Refrigerant 18 and POE lubricant.

A preferred heat transfer composition comprises Refrigerant 19 and POE lubricant.

A preferred heat transfer composition comprises Refrigerant 20 and POE lubricant.

A preferred heat transfer composition comprises Refrigerant 21 and POE lubricant.

A preferred heat transfer composition comprises Refrigerant 22 and POE lubricant.

A preferred heat transfer composition comprises Refrigerant 23 and POE lubricant.

A preferred heat transfer composition comprises Refrigerant 24 and POE lubricant.

A preferred heat transfer composition comprises Refrigerant 25 and POE lubricant.

A lubricant consisting essentially of a POE having a viscosity at 40° C. measured in accordance with ASTM D445 of from about 30 to about 70 is referred to herein as Lubricant 1.

A preferred heat transfer composition comprises Refrigerant 1 and Lubricant 1.

A preferred heat transfer composition comprises Refrigerant 2 and Lubricant 1.

A preferred heat transfer composition comprises Refrigerant 3 and Lubricant 1.

A preferred heat transfer composition comprises Refrigerant 4 and Lubricant 1.

A preferred heat transfer composition comprises Refrigerant 5 and Lubricant 1.

A preferred heat transfer composition comprises Refrigerant 6 and Lubricant 1

A preferred heat transfer composition comprises Refrigerant 7 and Lubricant 1.

A preferred heat transfer composition comprises Refrigerant 8 and Lubricant 1.

A preferred heat transfer composition comprises Refrigerant 9 and Lubricant 1.

A preferred heat transfer composition comprises Refrigerant 10 and Lubricant 1.

A preferred heat transfer composition comprises Refrigerant 11 and Lubricant 1.

A preferred heat transfer composition comprises Refrigerant 12 and Lubricant 1.

A preferred heat transfer composition comprises Refrigerant 13 and Lubricant 1.

A preferred heat transfer composition comprises Refrigerant 14 and Lubricant 1.

A preferred heat transfer composition comprises Refrigerant 15 and Lubricant 1.

A preferred heat transfer composition comprises Refrigerant 16 and Lubricant 1.

A preferred heat transfer composition comprises Refrigerant 17 and Lubricant 1.

A preferred heat transfer composition comprises Refrigerant 18 and Lubricant 1.

A preferred heat transfer composition comprises Refrigerant 19 and Lubricant 1.

A preferred heat transfer composition comprises Refrigerant 20 and Lubricant 1.

A preferred heat transfer composition comprises Refrigerant 21 and Lubricant 1.

A preferred heat transfer composition comprises Refrigerant 22 and Lubricant 1.

A preferred heat transfer composition comprises Refrigerant 23 and Lubricant 1.

A preferred heat transfer composition comprises Refrigerant 24 and Lubricant 1.

A preferred heat transfer composition comprises Refrigerant 25 and Lubricant 1.

A lubricant consisting essentially of a POE having a viscosity at 40° C. measured in accordance with ASTM D445 of from about 30 to about 70 and which is present in an amount of from about 0.1% to about 1% based on the weight of the heat transfer composition, is referred to herein as Lubricant 2.

A preferred heat transfer composition comprises Refrigerant 1 and Lubricant 2.

A preferred heat transfer composition comprises Refrigerant 2 and Lubricant 2.

A preferred heat transfer composition comprises Refrigerant 3 and Lubricant 2.

A preferred heat transfer composition comprises Refrigerant 4 and Lubricant 2.

A preferred heat transfer composition comprises Refrigerant 5 and Lubricant 2.

A preferred heat transfer composition comprises Refrigerant 6 and Lubricant 2.

A preferred heat transfer composition comprises Refrigerant 7 and Lubricant 2.

A preferred heat transfer composition comprises Refrigerant 8 and Lubricant 2.

A preferred heat transfer composition comprises Refrigerant 9 and Lubricant 2.

A preferred heat transfer composition comprises Refrigerant 10 and Lubricant 2.

A preferred heat transfer composition comprises Refrigerant 11 and Lubricant 2.

A preferred heat transfer composition comprises Refrigerant 12 and Lubricant 2.

A preferred heat transfer composition comprises Refrigerant 13 and Lubricant 2.

A preferred heat transfer composition comprises Refrigerant 14 and Lubricant 2.

A preferred heat transfer composition comprises Refrigerant 15 and Lubricant 2.

A preferred heat transfer composition comprises Refrigerant 16 and Lubricant 2.

A preferred heat transfer composition comprises Refrigerant 17 and Lubricant 2.

A preferred heat transfer composition comprises Refrigerant 18 and Lubricant 2.

A preferred heat transfer composition comprises Refrigerant 19 and Lubricant 2.

A preferred heat transfer composition comprises Refrigerant 20 and Lubricant 2.

A preferred heat transfer composition comprises Refrigerant 21 and Lubricant 2.

A preferred heat transfer composition comprises Refrigerant 22 and Lubricant 2.

A preferred heat transfer composition comprises Refrigerant 23 and Lubricant 2.

A preferred heat transfer composition comprises Refrigerant 24 and Lubricant 2.

A preferred heat transfer composition comprises Refrigerant 25 and Lubricant 2.

A preferred heat transfer composition comprises a refrigerant of the present invention, including each of Refrigerants 1-25, and from about 0.1% to about 5%, or from about 0.1% to about 1%, or from about 0.1% to about 0.5%, of a lubricant, wherein said percentage is based on the weight of the lubricant in the heat transfer composition.

A preferred heat transfer composition comprises a refrigerant of the present invention, including each of Refrigerants 1-25, and from about 0.1% to about 5%, or from about 0.1% to about 1%, or from about 0.1% to about 0.5%, of a POE lubricant, wherein said percentage is based on the weight of the lubricant in the heat transfer composition.

A preferred heat transfer composition comprises a refrigerant of the present invention, including each of Refrigerants 1-25, and from about 0.1% to about 5% or from about 0.1% to about 1% of a Lubricant 1, wherein said percentage is based on the weight of the lubricant in the heat transfer composition.

A lubricant consisting essentially of a POE having a viscosity at 40° C. measured in accordance with ASTM D445 of from about 30 to about 70 and which is present in an amount of from about 0.1% to about 0.5% based on the weight of the heat transfer composition, is referred to herein as Lubricant 3.

A preferred heat transfer composition comprises a refrigerant of the present invention, including each of Refrigerants 1-25, and Lubricant 3.

A lubricant consisting essentially of a POE having a viscosity at 40° C. measured in accordance with ASTM D445 of from about 30 to about 70 and which is present in an amount of from about 0.1% to about 0.5% based on the weight of the heat transfer composition, is referred to herein as Lubricant 4.

A preferred heat transfer composition comprises a refrigerant of the present invention, including each of Refrigerants 1-25, and Lubricant 4.

Other additives not mentioned herein can also be included by those skilled in the art in view of the teaching contained herein without departing from the novel and basic features of the present invention.

Combinations of surfactants and solubilizing agents may also be added to the present compositions to aid oil solubility as disclosed in U.S. Pat. No. 6,516,837, the disclosure of which is incorporated by reference in its entirety.

### Methods, Uses and Systems

The refrigerants and heat transfer compositions as disclosed herein are provided for use in air conditioning applications, including: mobile air conditioning (including air conditioning in cars, buses, trains and planes, including systems in such vehicles that have internal combustion engines, electrical power sources and hybrid power sources); stationary air conditioning, including residential air conditioning (including particularly residential air conditioning and in particular ducted split or a ductless split, window or portable air-conditioning systems); industrial air conditioning (including chiller systems); commercial air conditioning systems (including particularly chiller systems, packaged rooftop units and a variable refrigerant flow (VRF) systems).

The refrigerants and heat transfer compositions as disclosed herein are provided for use in heat pumps, including: mobile heat pumps (including electrical and hybrid vehicle heat pumps); residential heat pumps (including air residential air to water heat pump/hydronic systems); and commercial air source, water source or ground source heat pump systems.

The refrigerants and heat transfer compositions as disclosed herein are provided for use in chillers, including particularly positive displacement chillers, air cooled or water-cooled direct expansion chillers (which can be either modular or conventionally singularly packaged),

The refrigerants and heat transfer compositions as disclosed herein are provided for use in heat transfer applications, including low temperature refrigeration systems, including low temperature commercial refrigeration systems (including low temperature supermarket refrigeration systems) and low temperature transportation systems).

The refrigerants and heat transfer compositions as disclosed herein are provided for use in medium temperature refrigeration systems, including medium temperature commercial refrigeration systems (including medium temperature supermarket refrigeration systems and medium temperature transportation systems).

The compositions of the invention may be employed in systems which are suitable for use with R-410A refrigerant, such as new and existing heat transfer systems.

Any reference to the heat transfer composition of the invention refers to each and any of the heat transfer compositions as described herein. Thus, for the foregoing or following discussion of the uses or applications of the composition of the invention, the heat transfer composition may comprise or consist essentially of, or consist of any of the refrigerants described herein in combination with lubricants discussed herein, including: (i) each of Refrigerants 1-25; (ii) any combination of each of Refrigerants 1 -25 and any additive; (iii) any combination of each of Refrigerants 1-25 and any lubricant, including POE lubricants and Lubricants 1 - 3; and (iv) and any combination of each of Refrigerants 1 - 25 and PAG lubricant.

For heat transfer systems of the present invention that include a compressor and lubricant for the compressor in the system, the system can comprises a loading of refrigerant and lubricant such that the lubricant loading in the system is from about 5% to 60% by weight, or from about 10% to about 60% by weight, or from about 20% to about 50% by weight, or from about 20% to about 40% by weight, or from about 20% to about 30% by weight, or from about 30% to about 50% by weight, or from about 30% to about 40% by weight. As used herein, the term “lubricant loading” refers to the total weight of lubricant contained in the system as a percentage of total of lubricant and refrigerant contained in the system. Such systems may also include a lubricant loading of from about 5% to about 10% by weight, or about 8% by weight of the heat transfer composition.

Exemplary Heat Transfer Systems

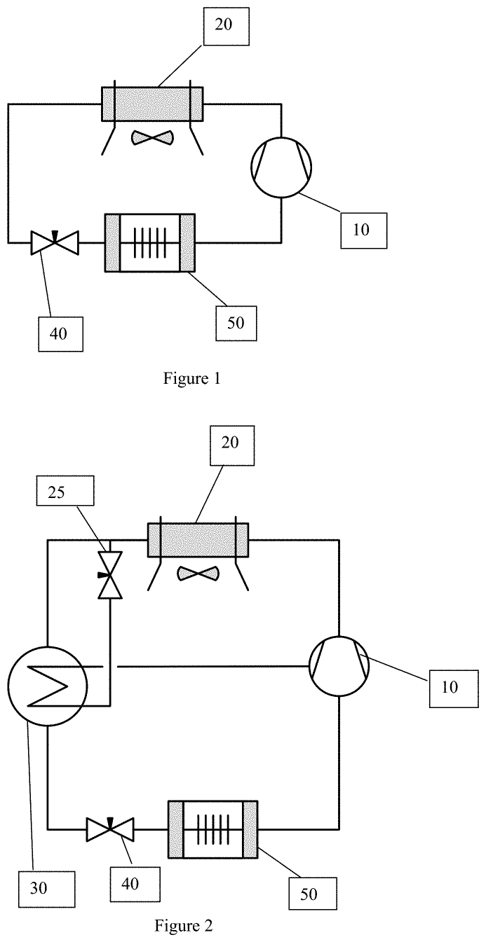

As described in detail below, the preferred systems of the present invention comprise a compressor, a condenser, an expansion device and an evaporator, all connected in fluid communication using piping, valving and control systems such that the refrigerant and associated components of the heat transfer composition can flow through the system in known fashion to complete the refrigeration cycle. An exemplary schematic of such a basic system is illustrated in FIG. 1. In particular, the system schematically illustrated in FIG. 1 shows a compressor 10, which provides compressed refrigerant vapor to condenser 20. The compressed refrigerant vapor is condensed to produce a liquid refrigerant which is then directed to an expansion device 40 that produces refrigerant at reduced temperature pressure, which in turn is then provided to evaporator 50. In evaporator 50 the liquid refrigerant absorbs heat from the body or fluid being cooled, thus producing a refrigerant vapor which is then provided to the suction line of the compressor. The refrigeration system illustrated in FIG. 2 is the same as described above in connection with FIG. 1 except that it includes a vapor injection system including heat exchanger 30 and bypass expansion valve 25. The bypass expansion device 25 diverts a portion of the refrigerant flow at the condenser outlet through the device and thereby provides liquid refrigerant to heat exchanger 30 at a reduced pressure, and hence at a lower temperature, to heat exchanger 30. This relatively cool liquid refrigerant then exchanges heat with the remaining, relatively high temperature liquid from the condenser. This operation produces a subcooled liquid to the main expansion device 40 and evaporator 50 and returns a relatively cool refrigerant vapor to the compressor 10. In this way the injection of the cooled refrigerant vapor into the suction side of the compressor serves to maintain compressor discharge temperatures in acceptable limits, which can be especially advantageous in low temperature systems that utilize high compression ratios.

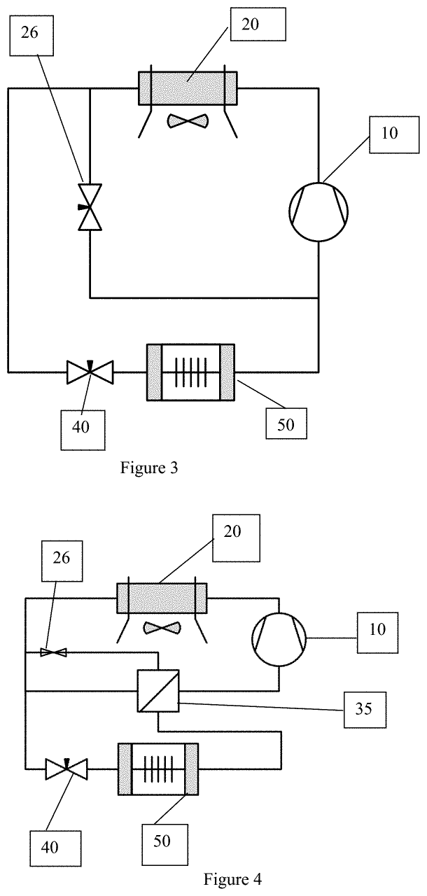

The refrigeration system illustrated in FIG. 3 is the same as described above in connection with FIG. 1 except that it includes a liquid injection system including bypass valve 26. The bypass valve 26 diverts a portion of the liquid refrigerant exiting the condenser to the compressor, preferably to a liquid injection port in the compressor 10. In this way the injection of liquid refrigerant into the suction side of the compressor serves to maintain compressor discharge temperatures in acceptable limits, which can be especially advantageous in low temperature systems that utilize high compression ratios.

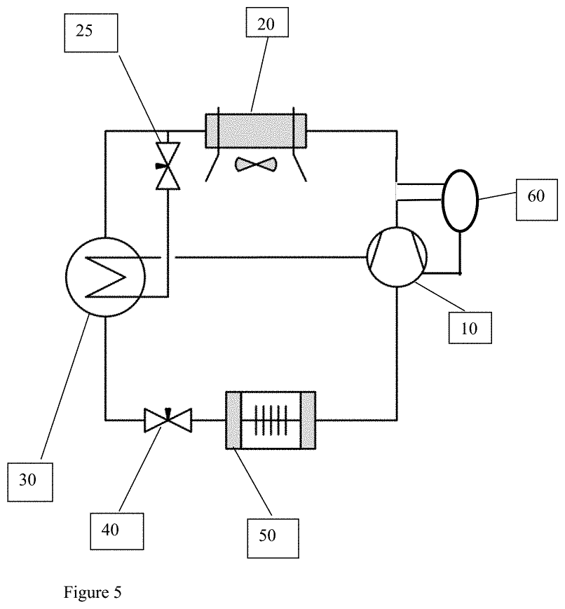

The refrigeration system illustrated in FIG. 4 is the same as described above in connection with FIG. 1 except that it includes a liquid line/suction line heat exchanger 35.

The valve 25 diverts a portion, and optionally all, of the of the refrigerant flow from the condenser outlet to the liquid line/suction line heat exchanger, where heat is transferred from the liquid refrigerant to the refrigerant vapor leaving evaporator 50, and the further cooled liquid refrigerant leaving the heat exchanger 35 is directed to expansion device 40 and evaporator 50.

The refrigeration system illustrated in FIG. 5 is the same as described above in connection with FIG. 1 except that it includes an oil separator 60 connected to the outlet of the compressor 10. As is known to those skilled in the art, some amount of compressor lubricant will typically be carried over into the compressor discharge refrigerant vapor, and the oil separator is included to provide means to disengage the lubricant liquid from the refrigerant vapor, and a result refrigerant vapor which has a reduced lubricant oil content, proceeds to the condenser inlet and liquid lubricant is then returned to the lubricant reservoir for use in lubricating the compressor, such as a lubricant receiver. In preferred embodiments, the oil separator includes the sequestration materials described herein, preferably in the form of a filter or solid core.

It will be appreciated by those skilled in the art that the different equipment/configuration options shown separately in each of FIGS. 2-5 can be combined and used together as deemed advantageous for any application. Residential Air Conditioning Systems

The heat transfer systems according to the present invention include residential air conditioning systems that comprise a compressor, an evaporator, a condenser and an expansion device, in fluid communication with each other, a refrigerant of the invention, including each of Refrigerants 1-25 and a lubricant, including each of POE lubricant, PVE lubricant and Lubricant 1-3.

The heat transfer systems according to the present invention include residential air conditioning systems that comprise a compressor, an evaporator, a condenser and an expansion device, in fluid communication with each other, a refrigerant of the invention, including each of Refrigerants 1-25, a lubricant, including each of POE lubricant, PVE lubricant and Lubricant 1-3 and a sequestration material, including each of Sequestration Materials 1-6.

The heat transfer systems according to the present invention include residential air conditioning systems that comprise a compressor, an evaporator, a condenser and an expansion device, in fluid communication with each other, a refrigerant of the invention, including each of Refrigerants 1-25, a lubricant, including each of POE lubricant, PVE lubricant and Lubricant 1-3, and a stabilizer, including each of Stabilizers 1-17.

The heat transfer systems according to the present invention include residential air conditioning systems that comprise a compressor, an evaporator, a condenser and an expansion device, in fluid communication with each other, a refrigerant of the invention, including each of Refrigerants 1-25, a lubricant, including each of POE lubricant, PVE lubricant and Lubricant 1-3, and a stabilizer, including each of Stabilizers 1-17 and a sequestration material, including each of Sequestration Materials 1-6.

The heat transfer systems according to the present invention include residential air conditioning systems that comprise a compressor, an evaporator, a condenser and an expansion device, in fluid communication with each other, Refrigerant 1, POE lubricant, and stabilizer, including each of Stabilizers 1-17.

The heat transfer systems according to the present invention include residential air conditioning systems that comprise a compressor, an evaporator, a condenser and an expansion device, in fluid communication with each other, Refrigerant 1, POE lubricant, Stabilizer 1, and sequestration material selected from Sequestration Materials 1-6.

The heat transfer systems according to the present invention include residential air conditioning refrigeration systems that comprise a compressor, an evaporator having an evaporator operating temperature of about −20° C. to about 20° C., a condenser and an expansion device, any of Refrigerant 1-25, a POE lubricant and any of Stabilizer 1-17.

The heat transfer systems according to the present invention include residential air conditioning refrigeration systems operating in the cooling mode that comprise a compressor, an evaporator having an evaporator operating temperature of about 0° C. to about 20° C., a condenser and an expansion device, any of Refrigerant 1-25, a POE lubricant and any of Stabilizer 1-17.

The heat transfer systems according to the present invention include residential air conditioning refrigeration systems operating in the cooling mode that comprise a compressor, an evaporator having an evaporator operating temperature of about 0° C. to about 10° C., a condenser and an expansion device, any of Refrigerant 1-25, a POE lubricant and any of Stabilizer 1-17.

The heat transfer systems according to the present invention include residential air conditioning refrigeration systems operating in the cooling mode that comprise a compressor, an evaporator having an evaporator operating temperature of about 7° C., a condenser and an expansion device, any of Refrigerant 1-25, a POE lubricant and any of Stabilizer 1-17.

The heat transfer systems according to the present invention include residential air conditioning refrigeration systems operating in the heating mode that comprise a compressor, an evaporator having an evaporator operating temperature of about −20° C. to about 3° C., a condenser and an expansion device, any of Refrigerant 1-25, a POE lubricant and any of Stabilizer 1-17.

The heat transfer systems according to the present invention include residential air conditioning refrigeration systems operating in the heating mode that comprise a compressor, an evaporator having an evaporator operating temperature of about 0.5° C., a condenser and an expansion device, any of Refrigerant 1-25, a POE lubricant and any of Stabilizer 1-17.

For each of the residential air conditioning systems described herein operating in the cooling mode, the condenser preferably operates with a condensing temperature in the range of from about 40° C. to about 70° C.

For each of the residential air conditioning systems described herein operating in the heating mode, the condenser preferably operates with a condensing temperature in the range of from about 35° C. to about 50° C.

For each of the residential air conditioning systems described herein operating in the cooling mode, the system preferably provides cool air (said air having a temperature of for example, about 10° C. to about 17° C., particularly about 12° C.) to buildings for example, in the summer.

For each of the residential air conditioning systems described herein operating in the heating mode, that is, as a heat pump, the system preferably provides warm air, with the supplied warm air having a temperature of for example, about 18° C. to about 24° C., particularly about 21° C., to buildings in the winter. It is usually the same system as the residential air-conditioning system that operates in the cooling mode; however, while operating in the heat pump mode the refrigerant flow is reversed and the indoor coil becomes a condenser and the outdoor coil becomes an evaporator.

### Air Cooled Chiller Systems

The heat transfer systems according to the present invention include air cooled chiller systems that comprise a compressor, an evaporator, a condenser and an expansion device, in fluid communication with each other, a refrigerant of the invention, including each of Refrigerants 1-25 and a lubricant, including each of POE lubricant, PVE lubricant and Lubricant 1-3.

For each of the of the chiller systems described herein, including operating in a commercial air conditioning system, the chiller preferably provides chilled water, preferably at a temperature of for example, about 5° C. to about 10° C., particularly about 7° C.) to large buildings such as offices and hospitals, etc. Depending on the application, the chiller system may be running all year long. The chiller system may be air-cooled or water-cooled. In the air-cooled systems, the condenser exchanges heat with (i.e., rejects heat) to ambient air. In the water-cooled systems, the condenser exchanges heat with (i.e., rejects heat) with water, for example, from cooling tower or lake, sea and other natural resources.

For each of the chiller systems described herein, the condenser preferably operates with a condensing temperature in the range of from about 40° C. to about 70° C.

### Residential Air to Water Heat Pump Hydronic System

The heat transfer systems according to the present invention include residential air to water heat pumps that comprise a compressor, an evaporator, a condenser and an expansion device, in fluid communication with each other, a refrigerant of the invention, including each of Refrigerants 1-25 and a lubricant, including each of POE lubricant, PVE lubricant and Lubricant 1-3.

For each of the residential air to water heat pumps described herein, the system preferably provides hot water, with the water preferably having a temperature of for example about 50° C. or about 55° C., to buildings for floor heating or similar applications in the winter.

For each of the residential air to water heat pumps described herein, the condenser preferably operates with a condensing temperature in the range of from about 50° C. to about 90° C.

### Low Temperature Systems

The heat transfer systems according to the present invention include low temperature heat transfer systems that comprise a compressor, an evaporator, a condenser and an expansion device, in fluid communication with each other, a refrigerant of the invention, including each of Refrigerants 1-25, a lubricant, including each of POE lubricant, PVE lubricant and Lubricant 1-3.

Medium Temperature Systems

The heat transfer systems according to the present invention include medium temperature heat transfer systems that comprise a compressor, an evaporator, a condenser and an expansion device, in fluid communication with each other, a refrigerant of the invention, including each of Refrigerants 1-25, a lubricant, including each of POE lubricant, PVE lubricant and Lubricant 1-3.

Cooling Methods

The present invention includes methods for providing cooling comprising:
(a) evaporating a refrigerant according to the present invention (including any refrigerant selected from each of Refrigerants 1-25), in the vicinity of the body or article or fluid to be cooled at a temperature of from about −40° C. to about +10° C. to produce a refrigerant vapor;
(b) compressing said refrigerant vapor to produce a refrigerant at discharge temperature of less than about 135° C.; and
(c) condensing the refrigerant from said compressor at a temperature of from about 20° C. to about 70° C. to produce a refrigerant vapor.

Particular cooling methods are described in more detail below.

Residential Air Conditioning

The present invention includes methods of providing residential air conditioning in the cooling mode, said method comprising:
(a) evaporating a refrigerant according to the present invention (including any refrigerant selected from each of Refrigerants 1-25), at a temperature of from about 0° C. to about 10° C. to produce a refrigerant vapor;
(b) compressing said refrigerant vapor to produce a refrigerant at discharge temperature of less than about 135° C.; and
(c) condensing the refrigerant from said compressor at a temperature of from about 40° C. to about 70° C. to produce a refrigerant vapor.

The present invention includes methods of providing residential air conditioning in the cooling mode, said method comprising:
(a) evaporating a refrigerant according to the present invention (including any refrigerant selected from each of Refrigerants 1-25), at a temperature of from about 0° C. to about 10° C. to produce a refrigerant vapor and cooled air at a temperature of from about 10° C. to about 17° C.;
(b) compressing said refrigerant vapor to produce a refrigerant at discharge temperature of less than about 135° C.; and
(c) condensing the refrigerant from said compressor at a temperature of from about 40° C. to about 70° C. to produce a refrigerant vapor.

Chillers

The present invention includes methods of providing chilled water to provide air conditioning in the cooling mode, said method comprising:
(a) evaporating a refrigerant according to the present invention (including any refrigerant selected from each of Refrigerants 1-25), at a temperature of from about 0° C. to about 10° C. to produce a refrigerant vapor;
(b) compressing said refrigerant vapor to produce a refrigerant at discharge temperature of less than about 135° C.; and
(c) condensing the refrigerant from said compressor at a temperature of from about 40° C. to about 70° C. to produce a refrigerant vapor.

Low Temperature Cooling Methods

The present invention also includes low temperature refrigeration methods for transferring heat, said method comprising:
(a) evaporating a refrigerant according to the present invention (including any refrigerant selected from each of Refrigerants 1-25), at a temperature of from about −40° C. to about −12° C. to produce a refrigerant vapor;
(b) compressing said refrigerant vapor to produce a refrigerant at discharge temperature of less than about 135° C.; and
(c) condensing the refrigerant from said compressor at a temperature of from about 20° C. to about 60° C. to produce a refrigerant vapor.

Medium Temperature Cooling Methods

The present invention also includes medium temperature refrigeration methods for transferring heat, said method comprising:
(a) evaporating a refrigerant according to the present invention (including any refrigerant selected from each of Refrigerants 1-25), at a temperature of from −12° C. to about 0° C. to produce a refrigerant vapor;
(b) compressing said refrigerant vapor to produce a refrigerant at discharge temperature of less than about 135° C.; and
(c) condensing the refrigerant from said compressor at a temperature of from about 20° C. to about 60° C. to produce a refrigerant vapor.

Heating Methods

The present invention includes methods for providing heating comprising:
(a) evaporating a refrigerant according to the present invention (including any refrigerant selected from each of Refrigerants 1-25) at a temperature of from about −30° C. to about +5° C. to produce a refrigerant vapor;
(b) compressing said refrigerant vapor to produce a refrigerant at discharge temperature of less than about 135° C.; and
(c) condensing the refrigerant from said compressor in the vicinity of the body or article or fluid to be heated, said condensing occurring at a temperature of from about 40° C. to about 70° C. to produce a refrigerant vapor.

Particular heating methods are described in more detail below.

Residential Air Conditioning

The present invention includes methods of providing residential air conditioning in the heating mode, said method comprising:
(a) evaporating a refrigerant according to the present invention (including any refrigerant selected from each of Refrigerants 1-25), at a temperature of from about −20° C. to about 3° C. to produce a refrigerant vapor;
(b) compressing said refrigerant vapor to produce a refrigerant at discharge temperature of less than about 135° C.; and
(c) condensing the refrigerant from said compressor at a temperature of from about 40° C. to about 70° C. to produce a refrigerant vapor.

The present invention includes methods of providing residential air conditioning in the heating mode, said method comprising:
(a) evaporating a refrigerant according to the present invention (including any refrigerant selected from each of Refrigerants 1-25), at a temperature of from about 0.5° C. to produce a refrigerant vapor;
(b) compressing said refrigerant vapor to produce a refrigerant at discharge temperature of less than about 135° C.; and
(c) condensing the refrigerant from said compressor at a temperature of from about 40° C. to about 70° C. to produce a refrigerant vapor and heated air at a temperature of from about 18° C. to about 24° C.

Residential Air to Water Heat Pump Hydronic System

The present invention includes methods of providing heating in a residential air to water heat pump, said method comprising:
(a) evaporating a refrigerant according to the present invention (including any refrigerant selected from each of Refrigerants 1-25), at a temperature of from about −30° C. to about 5° C. to produce a refrigerant vapor;
(b) compressing said refrigerant vapor to produce a refrigerant at discharge temperature of less than about 135° C.; and
(c) condensing the refrigerant from said compressor at a temperature of from about 50° C. to about 90° C. to produce a refrigerant vapor.

The present invention includes methods of providing heating in a residential air to water heat pump, said method comprising:
(a) evaporating a refrigerant according to the present invention (including any refrigerant selected from each of Refrigerants 1-25), at a temperature of from about −20° C. to about 3° C. to produce a refrigerant vapor;
(b) compressing said refrigerant vapor to produce a refrigerant at discharge temperature of less than about 135° C.; and
(c) condensing the refrigerant from said compressor at a temperature of from about 50° C. to about 90° C. to produce a refrigerant vapor.

The present invention includes methods of providing heating in a residential air to water heat pump, said method comprising:
(a) evaporating a refrigerant according to the present invention (including any refrigerant selected from each of Refrigerants 1-25), at a temperature of from about −30° C. to about 5° C. to produce a refrigerant vapor;
(b) compressing said refrigerant vapor to produce a refrigerant at discharge temperature of less than about 135° C.; and
(c) condensing the refrigerant from said compressor at a temperature of from about 50° C. to about 90° C. to produce a refrigerant vapor and heated water at a temperature of from about 50° C. to about 55° C.

### Uses

Residential Air Conditioning

The present invention includes the use of a heat transfer composition comprising Refrigerant 1, in residential air conditioning.

The present invention therefore includes the use of a heat transfer composition comprising Refrigerant 2, in residential air conditioning.

The present invention therefore includes the use of a heat transfer composition comprising Refrigerant 3, in residential air conditioning.

The present invention therefore includes the use of a heat transfer composition comprising Refrigerant 4, in residential air conditioning.

The present invention therefore includes the use of a heat transfer composition comprising Refrigerant 5, in residential air conditioning.

The present invention therefore includes the use of a heat transfer composition comprising Refrigerant 6, in residential air conditioning.

The present invention therefore includes the use of a heat transfer composition comprising Refrigerant 7, in a residential air conditioning.

The present invention therefore includes the use of a heat transfer composition comprising Refrigerant 8, in residential air conditioning.

The present invention therefore includes the use of a heat transfer composition comprising Refrigerant 9, in residential air conditioning.

The present invention therefore includes the use of a heat transfer composition comprising Refrigerant 10, in a residential air conditioning.

The present invention therefore includes the use of a heat transfer composition comprising Refrigerant 11, in a residential air conditioning.

The present invention therefore includes the use of a heat transfer composition comprising Refrigerant 12, in residential air conditioning.

The present invention therefore includes the use of a heat transfer composition comprising Refrigerant 13, in residential air conditioning.

The present invention therefore includes the use of a heat transfer composition comprising Refrigerant 14, in residential air conditioning.

The present invention therefore includes the use of a heat transfer composition comprising Refrigerant 15, in residential air conditioning.

The present invention therefore includes the use of a heat transfer composition comprising Refrigerant 16, in residential air conditioning.

The present invention therefore includes the use of a heat transfer composition comprising Refrigerant 17, in a residential air conditioning.

The present invention therefore includes the use of a heat transfer composition comprising Refrigerant 18, in residential air conditioning.

The present invention therefore includes the use of a heat transfer composition comprising Refrigerant 19, in residential air conditioning.

The present invention therefore includes the use of a heat transfer composition comprising Refrigerant 20, in a residential air conditioning.

The present invention therefore includes the use of a heat transfer composition comprising Refrigerant 21, in a residential air conditioning.

The present invention therefore includes the use of a heat transfer composition comprising Refrigerant 22, in a residential air conditioning.

The present invention therefore includes the use of a heat transfer composition comprising Refrigerant 23, in a residential air conditioning.

The present invention therefore includes the use of a heat transfer composition comprising Refrigerant 24, in a residential air conditioning.

The present invention therefore includes the use of a heat transfer composition comprising Refrigerant 25, in residential air conditioning.

Chillers

The present invention includes the use of a heat transfer composition comprising Refrigerant 1, in a chiller.

The present invention therefore includes the use of a heat transfer composition comprising Refrigerant 2, in a chiller.

The present invention therefore includes the use of a heat transfer composition comprising Refrigerant 3, in a chiller.

The present invention therefore includes the use of a heat transfer composition comprising Refrigerant 4, in a chiller.

The present invention therefore includes the use of a heat transfer composition comprising Refrigerant 5, in a chiller.

The present invention therefore includes the use of a heat transfer composition comprising Refrigerant 6, in a chiller.

The present invention therefore includes the use of a heat transfer composition comprising Refrigerant 7, in a residential air conditioning.

The present invention therefore includes the use of a heat transfer composition comprising Refrigerant 8, in a chiller.

The present invention therefore includes the use of a heat transfer composition comprising Refrigerant 9, in a chiller.

The present invention therefore includes the use of a heat transfer composition comprising Refrigerant 10, in a chiller.

The present invention therefore includes the use of a heat transfer composition comprising Refrigerant 11, in a chiller.

The present invention therefore includes the use of a heat transfer composition comprising Refrigerant 12, in a chiller.

The present invention therefore includes the use of a heat transfer composition comprising Refrigerant 13, in a chiller.

The present invention therefore includes the use of a heat transfer composition comprising Refrigerant 14, in a chiller.

The present invention therefore includes the use of a heat transfer composition comprising Refrigerant 15, in a chiller.

The present invention therefore includes the use of a heat transfer composition comprising Refrigerant 16, in a chiller.

The present invention therefore includes the use of a heat transfer composition comprising Refrigerant 17, in a residential air conditioning.

The present invention therefore includes the use of a heat transfer composition comprising Refrigerant 18, in a chiller.

The present invention therefore includes the use of a heat transfer composition comprising Refrigerant 19, in a chiller.

The present invention therefore includes the use of a heat transfer composition comprising Refrigerant 20, in a chiller.

The present invention therefore includes the use of a heat transfer composition comprising Refrigerant 21, in a chiller.

The present invention therefore includes the use of a heat transfer composition comprising Refrigerant 21, in a chiller.

The present invention therefore includes the use of a heat transfer composition comprising Refrigerant 22, in a chiller.

The present invention therefore includes the use of a heat transfer composition comprising Refrigerant 23, in a chiller.

The present invention therefore includes the use of a heat transfer composition comprising Refrigerant 24, in a chiller.

The present invention therefore includes the use of a heat transfer composition comprising Refrigerant 25, in a chiller.

Low Temperature Refrigeration

The present invention includes the use of a heat transfer composition comprising any refrigerant of the present invention, including each of Refrigerants 1-25, in a low temperature refrigeration system.

Medium Temperature Refrigeration

The present invention includes the use of a heat transfer composition comprising any refrigerant of the present invention, including each of Refrigerants 1-25, in a medium temperature refrigeration system.

Retrofit and Replacement

The heat transfer compositions and the refrigerants of the present invention (including each of Refrigerants 1-25 and all heat transfer compositions containing Refrigerants 1-25) therefore can be used as a retrofit refrigerant/heat transfer composition or as a replacement refrigerant/heat transfer composition.

The present invention thus includes methods of retrofitting existing heat transfer system designed for and containing R-410 refrigerant, without requiring substantial engineering modification of the existing system, particularly without modification of the condenser, the evaporator and/or the expansion valve.

The present invention thus includes methods of retrofitting existing heat transfer system designed for and containing R-410A refrigerant, without requiring substantial engineering modification of the existing system, particularly without modification of the condenser, the evaporator and/or the expansion valve.

The present invention thus also includes methods of using a refrigerant or heat transfer composition of the present invention (including each of Refrigerants 1-25 and all heat transfer compositions containing Refrigerants 1-25) as a retrofit for R-410A, and in particular as a retrofit for R-410A in a low temperature refrigeration system, without requiring substantial engineering modification of the existing system, particularly without modification of the condenser, the evaporator and/or the expansion valve.

The present invention thus also includes methods of using a refrigerant or heat transfer composition of the present invention (including each of Refrigerants 1-25 and all heat transfer compositions containing Refrigerants 1-25) replacement for R-410A in a medium temperature refrigeration system, without requiring substantial engineering modification of the existing system, particularly without modification of the condenser, the evaporator and/or the expansion valve.

The present invention thus also includes methods of using a refrigerant or heat transfer composition of the present invention (including each of Refrigerants 1-25 and all heat transfer compositions containing Refrigerants 1-25) as a replacement for R-410A in a low temperature refrigeration system.

The present invention thus also includes methods of using a refrigerant or heat transfer composition of the present invention (including each of Refrigerants 1-25 and all heat transfer compositions containing Refrigerants 1-25) as a replacement for R-410A in a medium temperature refrigeration system.

The present invention thus also includes methods of using a refrigerant or heat transfer composition of the present invention (including each of Refrigerants 1-25 and all heat transfer compositions containing Refrigerants 1-25) as a replacement for R-410AA, and in particular as a replacement for R-410A in a low temperature refrigeration system.

The present invention thus also includes methods of using a refrigerant or heat transfer composition of the present invention (including each of Refrigerants 1-25 and all heat transfer compositions containing Refrigerants 1-25) as a replacement for R-410A, and in particular as a replacement for R-410A in a medium temperature refrigeration system,

### Equipment for the Systems, Methods and Uses

Examples of commonly used compressors, for the purposes of this invention include reciprocating, rotary (including rolling piston and rotary vane), scroll, screw, and centrifugal compressors. Thus, the present invention provides each and any of the refrigerants, including each of Refrigerants 1-25, and/or heat transfer compositions as described herein, including those containing any one of Refrigerants 1-25, for use in a heat transfer system comprising a reciprocating, rotary (including rolling piston and rotary vane), scroll, screw, or centrifugal compressor.

Examples of commonly used expansion devices, for the purposes of this invention include a capillary tube, a fixed orifice, a thermal expansion valve and an electronic expansion valve. Thus, the present invention provides each and any of the refrigerants, including each of Refrigerants 1-25, and/or heat transfer compositions, including those containing any one of Refrigerants 1-25, as described herein for use in a heat transfer system comprising a capillary tube, a fixed orifice, a thermal expansion valve or an electronic expansion valve.

For the purposes of this invention, the evaporator and the condenser can each independently be selected from a finned tube heat exchanger, a microchannel heat exchanger, a shell and tube, a plate heat exchanger, and a tube-in-tube heat exchanger. Thus, the present invention provides each and any of the refrigerants and/or heat transfer compositions as described herein for use in a heat transfer system wherein the evaporator and condenser together form a finned tube heat exchanger, a microchannel heat exchanger, a shell and tube, a plate heat exchanger, or a tube-in-tube heat exchanger.

The heat transfer composition of the invention can be used in heating and cooling applications. In a particular feature of the invention, the heat transfer composition can be used in a method of cooling comprising condensing a heat transfer composition and subsequently evaporating said composition in the vicinity of an article or body to be cooled.

The heat transfer composition of the invention is provided for use in a low temperature refrigeration system, including use in each of the following:
low-temperature commercial refrigerator,
a low temperature commercial freezer,
an ice making machine,
a vending machine,
a low temperature transport refrigeration system,
an industrial freezer,
an industrial refrigerator and
a low temperature chiller.

The heat transfer composition of the invention is provided for use in a medium temperature refrigeration system, wherein the medium temperature refrigeration system is preferably used to chill food or beverages such as in a refrigerator or a bottle cooler. The system usually has an air-to-refrigerant evaporator to chill the food or beverage, a reciprocating, scroll or screw or rotary compressor, an air-to-refrigerant condenser to exchange heat with the ambient air, and a thermal or electronic expansion valve.

The heat transfer composition of the invention is provided for use in a low temperature refrigeration system, wherein said low temperature refrigeration system is preferably used in a freezer or an ice making machine. The system usually has an air-to-refrigerant evaporator to chill the food or beverage, a reciprocating, scroll or rotary compressor, an air-to-refrigerant condenser to exchange heat with the ambient air, and a thermal or electronic expansion valve.

Each of the heat transfer compositions described herein, including heat transfer compositions containing any one of Refrigerants 1-25, is particularly provided for use in a low temperature system with a reciprocating, rotary (rolling-piston or rotary vane) or scroll compressor.

Each of the heat transfer compositions described herein, including heat transfer compositions containing any one of Refrigerants 1-25, is particularly provided for use in a medium temperature system with a reciprocating, rotary (rolling-piston or rotary vane) or scroll compressor.

The heat transfer compositions and the refrigerants of the present invention (including each of Refrigerants 1-25 and all heat transfer compositions containing Refrigerants 1-25) therefore can be used as a replacement refrigerant/heat transfer composition for the refrigerant R-410A.

The present invention thus includes methods of replacing the refrigerant in a heat transfer system designed for or suitable for use with R-410A refrigerant.

It will be appreciated that when the heat transfer composition is used as a sub-150 GWP replacement for R-410A, stem, or is used in a heat transfer system, which is suitable for use with designed to contain or containing R-410A refrigerant, or is used in a heat transfer system which is suitable for use with R-410A refrigerant, the heat transfer composition may consist essentially of the refrigerant of the invention.

The compositions of the present invention exhibit many of the desirable characteristics of R-410A but have a sub-150 GWP while at the same time having operating characteristics i.e. capacity and efficiency (COP) that are substantially similar to or substantially match R-410A. This allows the claimed compositions to replace R-410A in existing heat transfer systems without requiring any significant system modification for example of the condenser, the evaporator and/or the expansion valve. The composition can therefore be used as a direct replacement which have been used with or are suitable for use with R-410A.

The refrigerants of the invention, including each of Refrigerants 1-25, therefore preferably exhibit operating characteristics compared with R-410A wherein the efficiency (COP) of the composition is from 95 to 105% of the efficiency of R-410A in heat transfer systems, in which the compositions of the invention are to replace the R-410A refrigerant.

The refrigerants of the invention, including each of Refrigerants 1-22, therefore preferably exhibits operating characteristics compared with R-410A wherein the capacity of the composition is from 97 to 103% of the capacity of R-410A in heat transfer systems, in which the compositions of the invention are to replace the R-410A refrigerant.

The refrigerants of the invention, including each of Refrigerants 1-22, therefore preferably exhibits operating characteristics compared with R-410A wherein the capacity of the composition is from 97 to 103% of the capacity of R-410A in heat transfer systems and wherein the efficiency (COP) is equal to or greater than the efficiency of R-410A in the heat transfer system, in which the compositions of the invention are to replace the R-410A refrigerant.

Preferably, the refrigerants of the invention, including each of Refrigerants 1-22, preferably exhibit operating characteristics compared with R-410A wherein the efficiency (COP) of the composition is from 100 to 105% of the efficiency of R-410A in heat transfer systems, in which the compositions of the invention are to replace the R-410A refrigerant.

In order to maintain reliability of the heat transfer system, it is preferred that the composition of the invention further exhibits the following characteristics compared with R-410A:
the discharge temperature is not greater than 10° C. higher than that of R-410A; and
the compressor pressure ratio is from 95 to 105% of the compressor pressure ratio of R-410A
   in heat transfer systems, in which the composition of the invention is used to replace the R-410A refrigerant.

The composition of the invention is alternatively provided to replace R-410A in refrigeration systems. Thus, each of the heat transfer compositions as described herein, including heat transfer compositions that include any one of Refrigerants 1-25 can be used to replace R-410A in any one of the systems disclosed herein.

The present invention relates to the use in a medium or low temperature refrigeration system of a refrigerant of the present invention, including each of Refrigerant 1-25, wherein the refrigerant
(a) has an efficiency (COP) from about 95% to about 105% of the efficiency of R-410A in said system; and
(b) is mildly flammable.

### EXAMPLES

The refrigerant compositions identified in Table A below were analyzed as described herein. Each composition was subjected to thermodynamic analysis to determine its ability to match the operating characteristics of R-410A in various refrigeration systems. The analysis was performed using experimental data collected for properties of various binary pairs of components used in the composition. The vapor/liquid equilibrium behavior of each component was determined and studied in a series of binary pairs with each of HFO-1234yf, HFC-32, and HFC-161. The composition of each binary pair was varied over a series of relative percentages in the experimental evaluation and the mixture parameters for each binary par were regressed to the experimentally obtained data. Vapor/liquid equilibrium behavior data for binary pairs are available in the National Institute of Science and Technology (NIST) Reference Fluid Thermodynamic and Transport Properties Database software (Refprop 9.1 NIST Standard Database 2013) were used for the Examples. The parameters selected for conducting the analysis were: same compressor displacement for all refrigerants, same operating conditions for all refrigerants, same compressor isentropic and volumetric efficiency for all refrigerants. In each Example, simulations were conducted using the measured vapor liquid equilibrium data. The simulation results are reported for each Example.

TABLE A
Refrigerants evaluated for Performance Examples

| | R32 | R1234yf | R161 | | |
|---|---|---|---|---|---|
| Refrigerant | (wt. %) | (wt. %) | (wt. %) | GWP | Flammability |
| A1 | 21.5 | 71.5 | 7% | 147 | 2 L |
| A2 | 21.5 | 70.5 | 8% | 147 | 2 L |
| A3 | 21.5 | 69.5 | 9% | 147 | 2 L |

### Example 1

### Residential Air-Conditioning System (Cooling)

A residential air-conditioning system used to supply cool air (about 12° C.) to buildings in the summer is tested. Typical system types include ducted split, ductless split, window, and portable air-conditioning systems. The system usually has an air-to-refrigerant evaporator (indoor coil), a compressor, an air-to-refrigerant condenser (outdoor coil), and an expansion device. The evaporator and condenser are commonly finned tube or microchannel heat exchangers. The compressor is commonly reciprocating, rotary (rolling-piston or rotary vane) or scroll compressor. The expansion device is commonly a capillary tube, a thermal or electronic expansion valve. The refrigerant evaporating temperature is commonly in the range of about 0 to about 10° C., while the condensing temperature is in the range of about 40 to about 70° C.

Refrigerants A1, A2, and A3 were used in a simulation of a residential air-conditioning system as described above and the performance results are reported in Table 1 below. Operating conditions were: Condensing temperature=46° C. (corresponding outdoor ambient temperature=35° C.); Condenser sub-cooling=5.5° C.; Evaporating temperature=7° C. (corresponding indoor ambient temperature=26.7° C.); Evaporator Superheat=5.5° C.; Isentropic Efficiency=70%; Volumetric Efficiency=100%; and Temperature Rise in Suction Line=5.5° C.

TABLE 1
Performance in Residential Air-Conditioning System (Cooling)

| | | | | | Discharge | |
|---|---|---|---|---|---|---|
| | | | Pressure | Discharge | Temp- | |
| | Capacity | Efficiency | ratio | Pressure | erature | Evap. |
| Refrig- | (% | (% | (% | (% | Difference | Glide |
| erant | R410A) | R410A) | R410A) | R410A) | (° C.) | (° C.) |
| R410A | 100% | 100% | 100% | 100% | 0.0 | 0.1 |
| A1 | 67% | 105% | 104% | 66% | 8.3 | 5.0 |
| A2 | 67% | 105% | 104% | 66% | 8.1 | 4.9 |
| A3 | 67% | 105% | 104% | 66% | 8.0 | 4.8 |

Table 1 shows the thermodynamic performance of a residential air-conditioning system compared to R410A system.
For new systems, compressor displacement can be increased to make up capacity.
Composition A1 to A3 show evaporator glide of 5.0° C. or less.

### Example 2

### Variable Refrigerant Flow Air-Conditioning System (Cooling)

Variable refrigerant flow air-conditioning systems (VRFs) are commonly used to supply cool air (about 12° C.) to buildings in the summer. VRFs are typically installed with an air conditioner inverter which adds a DC inverter to the compressor to support variable motor speed and thus variable refrigerant flow rather than simply perform on/off operation. By operating at varying speeds, VRF units work only at the needed rate allowing for substantial energy savings at load conditions. The compressor is usually rotary or scroll compressor. The expansion device is usually a thermal or electronic expansion valve. The refrigerant evaporating temperature is commonly in the range of about 0 to about 10° C., while the condensing temperature is commonly in the range of about 40 to about 70° C.

A VRF system used to supply cool air (about 12° C.) to buildings in the summer is tested. Refrigerants A1, A2, and A3 were used in a simulation of a VRF as described above and the performance results are reported in Table 2 below. Operating conditions were: Condensing temperature=46° C. (corresponding outdoor ambient temperature=35° C.); Condenser sub-cooling=5.5° C.; Evaporating temperature=7° C. (corresponding indoor ambient temperature=26.7° C.); Evaporator Superheat=5.5° C.; Isentropic Efficiency=70%; Volumetric Efficiency=100%; and Temperature Rise in Suction Line=5.5° C.

TABLE 2
Performance in VRF System (Cooling)

| | | | | | Discharge | |
|---|---|---|---|---|---|---|
| | | | Pressure | Discharge | Temp- | |
| | Capacity | Efficiency | ratio | Pressure | erature | Evap. |
| Refrig- | (% | (% | (% | (% | Difference | Glide |
| erant | R410A) | R410A) | R410A) | R410A) | (° C.) | (° C.) |
| R410A | 100% | 100% | 100% | 100% | 0.0 | 0.1 |
| A1 | 67% | 105% | 104% | 66% | 8.3 | 5.0 |
| A2 | 67% | 105% | 104% | 66% | 8.1 | 4.9 |
| A3 | 67% | 105% | 104% | 66% | 8.0 | 4.8 |

Table 2 shows the thermodynamic performance of a variable refrigerant flow air-conditioning systems compared to R410A system.
For new systems, compressor displacement can be increased to make up capacity.
Composition A1 to A3 show evaporator glide of 5.0° C. or less.

### Example 3

### Residential Heat pump System (Heating)

Residential heat pump system is used to supply warm air (21° C.) to buildings in the winter and is typically configured the same system as the residential air-conditioning system. However, when the system is operating in the heat pump mode, the refrigerant flow is reversed, and the indoor coil becomes a condenser and the outdoor coil becomes an vaporator. Typical system types are ducted split and ductless split heat pump system. The evaporator and condenser are typically finned tube or microchannel heat exchangers, and the compressor is typically a reciprocating or rotary (rolling-piston or rotary vane) or scroll compressor. The expansion device is commonly a capillary tube, a thermal or electronic expansion valve. The refrigerant evaporating temperature is commonly in the range of about −30 to about 5° C., while the condensing temperature is in the range of about 35 to about 50° C.

Refrigerants A1, A2, and A3 were used in a simulation of a residential heat pump system as described above and the performance results are in Table 3 below. Operating conditions were: Condensing temperature=41° C.; Condenser sub-cooling=5.5° C.; Evaporating temperature=0.5° C.; Evaporator Superheat=5.5° C.; Isentropic Efficiency=70%; Volumetric Efficiency=100%; and Temperature Rise in Suction Line=5.5° C.

TABLE 3
Performance in Residential Heat pump System (Heating)

| | | | | | Discharge | |
|---|---|---|---|---|---|---|
| | Heating | Heating | Pressure | Discharge | Temp- | |
| | Capacity | Efficiency | ratio | Pressure | erature | Evap. |
| Refrig- | (% | (% | (% | (% | Difference | Glide |
| erant | R410A) | R410A) | R410A) | R410A) | (° C.) | (° C.) |
| R410A | 100% | 100% | 100% | 100% | 0.0 | 0.1 |
| A1 | 66% | 104% | 104% | 66% | 9.2 | 5.0 |
| A2 | 66% | 104% | 104% | 66% | 9.0 | 4.9 |
| A3 | 66% | 104% | 104% | 66% | 8.8 | 4.8 |

Table 3 shows the thermodynamic performance of a residential heat pump system compared to R410A system.
For new systems, compressor displacement can be increased to make up capacity.
Composition A1 to A3 show evaporator glide of 5.0° C. or less.

### Example 4

### Commercial Air-Conditioning System—Chiller

Commercial air-conditioning systems (chillers) are commonly used to supply chilled water (about 7° C.) to large buildings such as offices, hospitals, etc. Depending on the application, the chiller system may be running all year long. The chiller system may be air-cooled or water-cooled. The air-cooled chiller usually has a plate, tube-in-tube or shell-and-tube evaporator to supply chilled water, a reciprocating or scroll compressor, a round tube plate fin or microchannel condenser to exchange heat with ambient air, and a thermal or electronic expansion valve. The water-cooled system usually has a shell-and-tube evaporator to supply chilled water, a reciprocating or scroll compressor, a shell-and-tube condenser to exchange heat with water from cooling tower or lake, sea and other natural recourses, and a thermal or electronic expansion valve. The refrigerant evaporating temperature is commonly in the range of about 0 to about 10° C., while the condensing temperature is in the range of about 40 to about 70° C.

A commercial air-conditioning system (chiller) used to supply chilled water (7° C.) to large buildings (such as office and hospital buildings) is tested and the performance results are reported in Table 4. Operating conditions were: Condensing temperature=46° C.; Condenser sub-cooling=5.5° C.; Evaporating temperature=4.5° C.; Evaporator Superheat=5.5° C.; Isentropic Efficiency=70%; Volumetric Efficiency=100%; and Temperature Rise in Suction Line=2° C.

TABLE 4
Performance in Commercial Air-Conditioning
System-Air-Cooled Chiller

| | | | | | Discharge | |
|---|---|---|---|---|---|---|
| | | | Pressure | Discharge | Temp- | |
| | Capacity | Efficiency | ratio | Pressure | erature | Evap. |
| Refrig- | (% | (% | (% | (% | Difference | Glide |
| erant | R410A) | R410A) | R410A) | R410A) | (° C.) | (° C.) |
| R410A | 100% | 100% | 100% | 100% | 0.0 | 0.1 |
| A1 | 67% | 105% | 104% | 66% | 8.8 | 4.9 |
| A2 | 67% | 105% | 104% | 66% | 8.6 | 4.8 |
| A3 | 67% | 105% | 104% | 66% | 8.5 | 4.7 |

Table 4 shows the thermodynamic performance of a commercial air-cooled chiller system compared to R410A system.
For new systems, compressor displacement can be increased to make up capacity.
Composition A1 to A3 show evaporator glide less than 5.0° C.

### Example 5

### Residential Air-to-Water Heat Pump Hydronic System

Residential air-to-water heat pump hydronic systems are typically used to supply hot water (about 55° C.) to buildings for floor heating or similar applications in the winter. The hydronic system usually has a finned or microchannel evaporator to exchange heat with ambient air, a reciprocating, rotary or scroll compressor, a plate, tube-in-tube or shell-and-tube condenser to heat the water, and a thermal or electronic expansion valve. The refrigerant evaporating temperature is typically in the range of about −30 to about 5° C., while the condensing temperature is typically in the range of about 50 to about 90° C.

A residential air-to-water heat pump hydronic system used to supply hot water (55° C.) to buildings for floor heating or similar applications in the winter is tested with Refrigerants A1, A2, and A3 and the performance results are reported in Table 5. Operating conditions were: Condensing temperature=60° C. (corresponding indoor leaving water temperature=50° C.); Condenser sub-cooling=5.5° C.; Evaporating temperature=0.5° C. (corresponding outdoor ambient temperature=8.3° C.); Evaporator Superheat=5.5° C.; Isentropic Efficiency=70%; Volumetric Efficiency=100%; and Temperature Rise in Suction Line=2° C.

TABLE 5
Performance in Residential Air-to-Water Heat Pump Hydronic System

| | | | | | Discharge | |
|---|---|---|---|---|---|---|
| | Heating | Heating | Pressure | Discharge | Temp- | |
| | Capacity | Efficiency | ratio | Pressure | erature | Evap. |
| Refrig- | (% | (% | (% | (% | Difference | Glide |
| erant | R410A) | R410A) | R410A) | R410A) | (° C.) | (° C.) |
| R410A | 100% | 100% | 100% | 100% | 0.0 | 0.1 |
| A1 | 64% | 104% | 106% | 66% | 14.1 | 3.9 |
| A2 | 65% | 104% | 106% | 66% | 13.8 | 3.9 |
| A3 | 65% | 104% | 106% | 66% | 13.5 | 3.8 |

Table 5 shows the thermodynamic performance of a residential air-to-water heat pump hydronic system compared to R410A system.
For new systems, compressor displacement can be increased to make up capacity.
Composition A1 to A3 show evaporator glide less than 5.0° C.

### Example 6

### Medium Temperature Refrigeration System

Medium temperature refrigeration systems are used to chill food or beverages such as in a refrigerator and bottle cooler. The system usually has an air-to-refrigerant evaporator to chill the food or beverage, a reciprocating, scroll or screw compressor, an air-to-refrigerant condenser to exchange heat with the ambient air, and a thermal or electronic expansion valve. The refrigerant evaporating temperature is in the range of about −12 to about 0° C., while the condensing temperature is in the range of about 20 to about 70° C.

A medium temperature refrigeration system used to chill the food or beverage such as in refrigerator and bottle cooler is tested with refrigerants A1, A2, and the performance results are reported in Table 6. Operating conditions were: Condensing temperature=40.6° C.; Condenser sub-cooling=5.5° C.; Evaporating temperature=−6.7° C.; Evaporator Superheat=5.5° C.; Isentropic Efficiency=70%; Volumetric Efficiency=100%; Degree of superheat in the suction line=15° C.

TABLE 6
Performance in Medium Temperature Refrigeration System

| | | | | | Discharge | |
|---|---|---|---|---|---|---|
| | | | Pressure | Discharge | Temp- | |
| | Capacity | Efficiency | ratio | Pressure | erature | Evap. |
| Refrig- | (% | (% | (% | (% | Difference | Glide |
| erant | R410A) | R410A) | R410A) | R410A) | (° C.) | (° C.) |
| R410A | 100% | 100% | 100% | 100% | 0.0 | 0.1 |
| A1 | 66% | 104% | 105% | 66% | 12.7 | 4.8 |
| A2 | 66% | 104% | 105% | 66% | 12.4 | 4.7 |
| A3 | 66% | 105% | 105% | 66% | 12.2 | 4.6 |

Table 6 shows the thermodynamic performance of a medium temperature refrigeration system compared to R410A system.
For new systems, compressor displacement can be increased to make up capacity.
Composition A1 to A3 show evaporator glide less than 5.0° C.

### Example 7

### Low Temperature Refrigeration System

Low temperature refrigeration systems are used to freeze food such as in an ice cream machine and a freezer. The system usually has an air-to-refrigerant evaporator, a reciprocating, scroll or screw compressor, an air-to-refrigerant condenser to exchange heat with the ambient air, and a thermal or electronic expansion valve. The refrigerant evaporating temperature is in the range of about −40 to about −12° C., while the condensing temperature is in the range of about 20 to about 70° C.

A low temperature refrigeration system used to freeze the food such as in ice cream machine and freezer is tested using refrigerants A1, A2, and A3 and the performance results are in Table 7. Operating conditions were: Condensing temperature=40.6° C.; Condenser sub-cooling=1° C.; Evaporating temperature=−31.6° C.; Degree of superheat at evaporator outlet =5.5° C.; Isentropic Efficiency=70%; Volumetric Efficiency=100%; Degree of superheat in the suction line=30.6° C.

TABLE 13
Performance in Low Temperature Refrigeration System

| | | | | | Discharge | |
|---|---|---|---|---|---|---|
| | | | Pressure | Discharge | Temp- | |
| | Capacity | Efficiency | ratio | Pressure | erature | Evap. |
| Refrig- | (% | (% | (% | (% | Difference | Glide |
| erant | R410A) | R410A) | R410A) | R410A) | (° C.) | (° C.) |
| R410A | 100% | 100% | 100% | 100% | 0.0 | 0.1 |
| A1 | 61% | 103% | 110% | 66% | 25.4 | 4.0 |
| A2 | 62% | 103% | 110% | 66% | 24.9 | 3.9 |
| A3 | 62% | 103% | 110% | 66% | 24.3 | 3.8 |

Table 13 shows the thermodynamic performance of a low temperature refrigeration system compared to R410A system.
For new systems, compressor displacement can be increased to make up capacity.
Composition A1 to A3 show evaporator glide less than 5.0° C.

### Example 8

### Mobile AC System Cooling

Mobile air conditioning (MAC) systems for internal combustion engine vehicles and hybrid electric vehicles and electric vehicles provide comfort cooling for passengers in cars, trucks, buses, planes, trains, and other forms of transportation. The evaporator is typically installed in the passenger cabin in the dashboard. Operating conditions can vary greatly as the vehicle is exposed to changes in season, elevation, and location, etc. Ambient conditions range from −40° C. to 45° C. with cabin cooling needs between 15° C. and 45° C.

The following operating conditions are used in the following example in which the system does not include an internal heat exchanger:
1. Condensing temperature=45° C.
2. Condenser sub-cooling=3 K
3. Evaporating temperature=5° C.
4. Evaporator Superheat=5 K
5. Isentropic Efficiency=70%
6. Volumetric Efficiency=100%
7. Temperature Rise in Suction Line=5 K

TABLE 14
Cooling Performance in MAC System without internal heat exchanger

| | | | | | Dis- | |
|---|---|---|---|---|---|---|
| | | | | | charge | |
| | | | | | Temp- | |
| | | | Pressure | Discharge | erature | |
| | Capacity | Efficiency | ratio | Pressure | Diff- | Evap. |
| Refrig- | (% | (% | (% | (% | erence | Glide |
| erant | R1234yf) | R1234yf) | R1234yf) | R1234yf) | (° C.) | (° C.) |
| R1234yf | 100% | 100% | 100% | 100% | 0.0 | 0.0 |
| A1 | 159% | 100% | 98% | 155% | 14.8 | 4.8 |
| A2 | 159% | 100% | 98% | 155% | 15.0 | 4.7 |
| A3 | 160% | 100% | 98% | 155% | 15.1 | 4.6 |

Composition A1 to A3 show evaporator glide less than 5.0° C.

Operating conditions for system with suction line liquid line heat exchanger:
1. Condensing temperature=45° C.
2. Condenser sub-cooling=0 K
3. Evaporating temperature=5° C.
4. Evaporator Superheat=0 K
5. Isentropic Efficiency=70%
6. Volumetric Efficiency=100%
7. Temperature Rise in Suction Line=0 K
8. Suction line liquid line heat exchanger effectiveness: 50%

TABLE 15
Cooling Performance in MAC System with internal heat exchanger

| | | | Pressure | Discharge | Discharge |
|---|---|---|---|---|---|
| | Capacity | Efficiency | ratio | Pressure | Temperature |
| Refrig- | (% | (% | (% | (% | Difference |
| erant | R1234yf) | R1234yf) | R1234yf) | R1234yf) | (° C.) |
| R1234yf | 100% | 100% | 100% | 100% | 0.0 |
| A1 | 156% | 99% | 98% | 155% | 12.0 |
| A2 | 156% | 99% | 98% | 155% | 12.2 |
| A3 | 157% | 99% | 98% | 155% | 12.4 |

### Example 9

### Mobile AC System—Heating Mode

Mobile air conditioning (MAC) systems for hybrid electric vehicles and electric vehicles frequently are required to provide heating of the passenger compartment in such vehicle, including cars, trucks, and buses. The use of the refrigerants of the present invention to replace R-1234yf in such systems provides beneficial results.

1. A refrigerant comprising at least about 98.5% by weight of the following three compounds, with each compound being present in the following relative percentages:
16.5% to 21.5% by weight difluoromethane (HFC-32);
68.5% to 80.5% by weight of 2,3,3,3-tetrafluoropropene (HFO-1234yf); and
3.0% to 10.0% by weight fluoroethane (HFC-161).

2. The refrigerant of claim 1 comprising at least about 99.5% by weight of said three compounds.

3. The refrigerant of claim 1 consisting essentially of said three compounds.

4. The refrigerant of claim 1 consisting of said three compounds.

5. The refrigerant of claim 1 comprising:
about 21.5% by weight difluoromethane (HFC-32);
about 70.5% by weight of 2,3,3,3-tetrafluoropropene (HFO-1234yf); and
about 8.0% by weight fluoroethane (HFC-161).

6. The refrigerant of claim 5 comprising at least about 99.5% by weight of said three compounds.

7. The refrigerant of claim 5 consisting essentially of said three compounds.

8. The refrigerant of claim 5 consisting of said three compounds.

9. The refrigerant comprising at least about 99.5% by weight of the following three compounds, with each compound being present in the following relative percentages:
21.5%+0.5/−2% by weight difluoromethane (HFC-32);
69.5%+/−2% by weight of 2,3,3,3-tetrafluoropropene (HFO-1234yf); and
9.0%+0.5/−2% by weight fluoroethane (HFC-161).

10. A heat transfer composition comprising the refrigerant of claim 1.

11. A heat transfer composition comprising the refrigerant of claim 9.

12. The heat transfer composition of claim 11, wherein the refrigerant comprises greater than 40% by weight of the heat transfer composition.

13. The heat transfer composition of claim 12 further comprising a stabilizer selected from an alkylated naphthalene, a diene-based compound, a phenol compound and combinations of two or more of these and further comprising a lubricant selected from the group consisting of polyol esters (POEs), mineral oil, alkylbenzenes (ABs) and polyvinyl ethers (PVE).

14. A method for transferring heat of the type comprising evaporating refrigerant liquid to produce a refrigerant vapor, compressing in a compressor at least a portion of the refrigerant vapor and condensing refrigerant vapor, said method comprising:
(a) providing a heat transfer composition comprising a refrigerant according to claim 1;
(b) evaporating said refrigerant at a temperature of from about −40° C. to about +10° C.

15. A method for transferring heat of the type comprising evaporating refrigerant liquid to produce a refrigerant vapor, compressing in a compressor at least a portion of the refrigerant vapor and condensing refrigerant vapor, said method comprising:
(a) providing a heat transfer composition comprising a refrigerant according to claim 9;
(b) evaporating said refrigerant at a temperature of from about −40° C. to about +10° C.

16. The method of claim 15 wherein said heat transfer composition further comprises a stabilizer.

17. The method of claim 14 wherein said evaporating step takes place in a system selected from residential air conditioning, variable refrigerant flow air conditioning, residential heat pumps, commercial air conditioning chillers, residential air-to-water heat pump hydronic systems, medium temperature refrigeration and low temperature refrigeration.

18. The method of claim 15 wherein said evaporating step takes place in a system selected from residential air conditioning, variable refrigerant flow air conditioning, residential heat pumps, commercial air conditioning chillers, residential air-to-water heat pump hydronic systems, medium temperature refrigeration and low temperature refrigeration.

19. The method of claim 17 wherein said heat transfer composition further comprises a lubricant selected from POE lubricant and PVE lubricant.

20. The method of claim 18 wherein said heat transfer composition further comprises a lubricant selected from POE lubricant and PVE lubricant.
